(19) United States
(12) Patent Application Publication
(10) Pub. No.: US 2009/0246103 A1
(43) Pub. Date: Oct. 1, 2009

(54) HONEYCOMB STRUCTURE AND METHOD FOR MANUFACTURING THE SAME

(75) Inventors: Kazushige Ohno, Ibi-Gun (JP); Masafumi Kunieda, Ibi-Gun (JP); Yoshihiro Koga, Ibi-Gun (JP)

Correspondence Address: DITTHAVONG MORI & STEINER, P.C., 918 Prince St., Alexandria, VA, 22314, US

(73) Assignee: IBIDEN CO., LTD., Ogaki-Shi (JP)

(21) Appl. No.: 12/246,899

(22) Filed: Oct. 7, 2008

(30) Foreign Application Priority Data
Mar. 27, 2008 (JP) PCT/JP2008/055973

(51) Int. Cl. B01J 35/04; B01D 53/04; B01J 23/38; B01J 21/02; B01J 23/42; B01J 23/10; B01J 21/08; B01J 21/12

(52) U.S. Cl. 422/222; 96/153; 502/325; 502/74; 502/339; 502/304; 502/261; 502/207

(57) ABSTRACT

A honeycomb structure includes at least one honeycomb unit having one end face and another end face opposite to the one end face along a longitudinal direction of the at least one honeycomb unit. The at least one honeycomb unit includes an inorganic binder, inorganic particles, cell walls extending along the longitudinal direction from one end face to the another end face to define plural cells, and third material provided on the cell walls. The inorganic particles include first and second materials. The first material includes NOx adsorption material. The second material includes ammonia adsorption material.

### CROSS-REFERENCE TO RELATED APPLICATIONS

The present application claims priority under 35 U.S.C §119 to PCT/JP2008/055973 filed Mar. 27, 2008, the entire contents of which are hereby incorporated herein by reference.

### BACKGROUND OF THE INVENTION

1. Field of the Invention

The present invention relates to a honeycomb structure and a method for manufacturing the same.

2. Description of the Related Art

Conventionally, a honeycomb structure has been used in an exhaust gas treatment apparatus for converting, for example, NOx in exhaust gas from a vehicle (see, for example, Japanese Patent Application Publication No.2006-183477).

The honeycomb structure has, for example, plural cells (through holes) extending from one end surface to the other end face along the longitudinal direction of the honeycomb structure. These cells are separated from each other by interposing cell walls.

The cell wall of the honeycomb structure includes, for example, ceramic such as cordierite, and is provided with an NOx adsorption layer and an ammonia adsorption layer. In the NOx adsorption layer, for example, ceria is used, and a catalyst such as platinum is supported on this layer. In the ammonia adsorption layer, for example, zeolite is used.

When exhaust gas from, for example, a vehicle is introduced in such a honeycomb structure, the NOx in the exhaust gas is adsorbed in the NOx adsorption layer in an oxidant atmosphere (for example, in a normal operation of a diesel engine), and then, in a reducing atmosphere (for example, in spiking of the diesel engine), the adsorbed NOx on the catalyst is reduced into ammonia, which is adsorbed in the ammonia adsorption layer. When the exhaust gas is in the oxidant atmosphere again, NOx is reduced by the ammonia. When the adsorbed ammonia is used up, NOx is adsorbed in the NOx adsorption layer. The NOx is converted due to this cycle.

Therefore, it is possible to convert NOx in exhaust gas when exhaust gas is introduced in the honeycomb structure.

The entire contents of JP-A-2006-183477 are hereby incorporated herein by reference.

### SUMMARY OF THE INVENTION

According to one aspect of the present invention, a honeycomb structure includes at least one honeycomb unit having one end face and another end face opposite to the one end face along a longitudinal direction of the at least one honeycomb unit. The at least one honeycomb unit includes an inorganic binder, inorganic particles, cell walls extending along the longitudinal direction from one end face to the another end face to define plural cells, and third material provided on the cell walls. The inorganic particles include first and second materials. The first material includes NOx adsorption material. The second material includes ammonia adsorption material.

According to another aspect of the present invention, a method of manufacturing a honeycomb structure includes manufacturing at least one honeycomb unit molded body using a raw material paste including inorganic particles and an inorganic binder; firing the at least one honeycomb unit molded body to obtain at least one honeycomb unit which comprises a plurality of cell walls extending from one end face to another end face of the at least one honeycomb unit along a longitudinal direction of the at least one honeycomb unit to define a plurality of cells; providing a noble metal catalyst on the cell walls of the at least one honeycomb unit; and coating a preliminary layer on the cell walls of the honeycomb unit.

### BRIEF DESCRIPTION OF THE DRAWINGS

Other objects, features, and advantages of the present invention will become more apparent from the following description when read in conjunction with the accompanying drawings, in which:

FIG. 1 is a schematic perspective view showing an example of a honeycomb structure according to an embodiment of the present invention;

FIG. 2 is a schematic perspective view showing an example of a honeycomb unit included in the honeycomb structure in FIG. 1;

FIG. 3 a schematic perspective view showing another example of a honeycomb structure according to an embodiment of the present invention;

FIG. 4 is a schematic view showing a cross-sectional structure of the cell wall of a conventional honeycomb structure; and

FIG. 5 is a schematic view showing a cross-sectional structure of the cell wall of a honeycomb structure according to an embodiment of the present invention.

### DETAILED DESCRIPTION OF THE PREFERRED EMBODIMENTS

Next, an exemplary embodiment of the present invention is described with reference to the accompanying drawings.

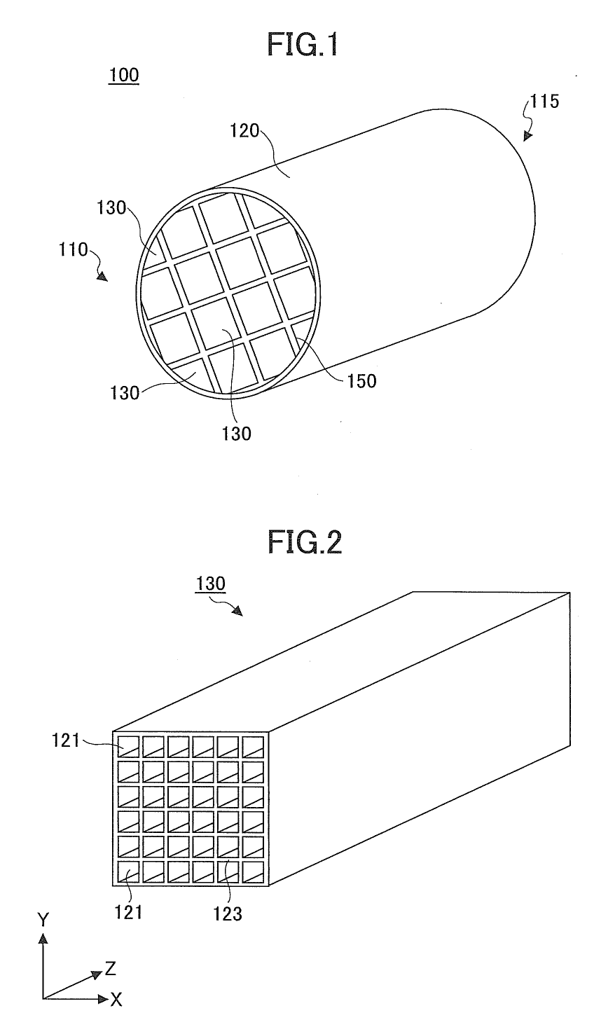

FIG. 1 schematically shows a honeycomb structure according to an embodiment of the present invention. FIG. 2 schematically shows an example of a honeycomb unit which is a basic configuration unit of the honeycomb structure in FIG. 1.

As shown in FIG. 1, the honeycomb structure 100 according to an embodiment of the present invention has two opening faces 110 and 115. A coating layer 120 is formed on an outer peripheral surface but is not formed on the two opening faces of the honeycomb structure 100.

The honeycomb structure 100 may be formed in a manner so that plural honeycomb units 130 each having a pillar shape as shown in FIG. 2 are joined with each other (in FIG. 1, 4 by 4 matrix (16 units)) by interposing adhesive layers 150, dried and solidified, and cut around the outer peripheral according to a prescribed shape (in the example of FIG. 1, a cylindrical shape).

As shown in FIG. 2, the honeycomb unit 130 has plural cells (through holes) 121 and cell walls 123 dividing the cells, each cell extending in the longitudinal direction of the honeycomb unit 130 from one end face to the other end face and having openings one on each end face.

To be able to understand more clearly about a characteristic effect of the honeycomb structure 100 according to an embodiment of the present invention, an exemplary configuration of a conventional honeycomb structure is first described.

In a conventional honeycomb structure, as described above, cordierite has been used as the base (skeleton) material, and the NOx adsorption layer and the ammonia adsorption layer are formed on a surface of the cell walls constituted the cordierite.

However, the cordierite itself as the base (skeleton) material for the conventional honeycomb structure does not react in the reaction of converting NOx. In other words, all the converting reaction is carried out by the two layers: the NOx adsorption layer and the ammonia adsorption layer. Therefore, to increase the efficiency of converting NOx in the honeycomb structure, it may be necessary to support a sufficient amount of the NOx adsorption layer and the ammonia adsorption layer formed on the cell walls. To this end, it may be necessary to increase the thicknesses of the two layers or to elongate the whole length of the cordierite. Otherwise, it may be necessary to increase the frequency of a rich-spiking operation.

However, when the thicknesses of the layers are increased, the size of the openings of the cell walls becomes smaller. As a result, when exhaust gas is introduced, a pressure loss is disadvantageously increased. Further, when the total length of the cordierite is extended, there arises a problem of installation space and the weight. Further, when the frequency of the rich-spiking operation is increased, the fuel consumption is disadvantageously increased.

According to an embodiment of the present invention, there may be provided a honeycomb structure having an excellent NOx conversion performance without increasing the thicknesses of the NOx adsorption layer and the ammonia adsorption layer on the cell walls and extending the total length of the cell walls.

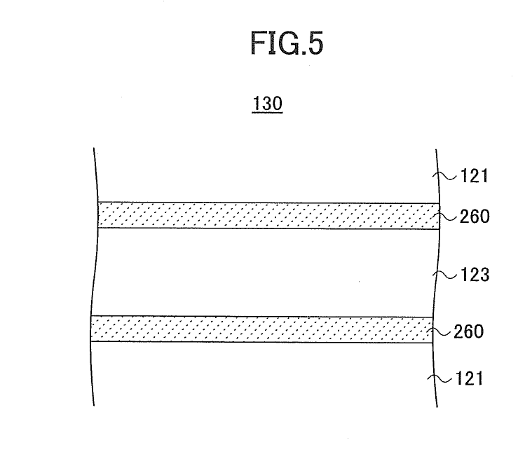

FIG. 4 schematically shows an enlarged cross section of the cell wall in a conventional honeycomb structure.

In a conventional honeycomb structure, a cell wall 123P of a honeycomb unit 130P includes cordierite. Further, an NOx adsorption layer 210 and an ammonia adsorption layer 220 are formed on the cell wall 123P of the honeycomb unit 130P. The NOx adsorption layer 210 includes ceria and a noble metal catalyst such as platinum. The ammonia adsorption layer 220 is formed outside of the NOx adsorption layer 210 and typically includes material such as zeolite. It is obvious for a person having ordinary skill in the art that each of the NOx adsorption layer 210 and the ammonia adsorption layer 220 is not uniformly (continuously) formed as a “layer” as shown in FIG. 4. Therefore, it should be noted that FIG. 4 is a symbolic view for illustrative purposes only.

When a conventional honeycomb structure including such a material group is placed in a flow of exhaust gas so that the exhaust gas is practically introduced in the honeycomb structure, the following phenomena are observed.

First, when the exhaust gas is in an oxidant atmosphere (for example, in a normal operation of a diesel engine), the NOx in the exhaust gas is adsorbed in the NOx adsorption layer 210. Next, rich-spiking is carried out so that the exhaust gas is in a reducing atmosphere. The HC is converted by a catalyst so that the generated H₂ and the NOx adsorbed in the NOx adsorption layer 210 react to generate ammonia according to the following reaction in Formula (1)

2NO+3H₂→2NH₃+O₂ Formula (1)

The ammonia generated in this reaction is adsorbed in the ammonia adsorption layer 220 adjacent to the NOx adsorption layer 210.

On the other hand, when the exhaust gas is in an oxidant atmosphere again, the NOx in the exhaust gas is reduced by the ammonia 30 n adsorbed in the ammonia adsorption layer 220 according to the following reactions in Formulas (2-1) and (2-2).

4NH₃+4NO+O₂→4N₂+6H₂O Formula (2-1)

8NH₃+6NO₂→7N₂+12H₂O Formula (2-2)

Further, when the ammonia adsorbed in the ammonia adsorption layer 220 is consumed, the NOx is adsorbed in the NOx adsorption layer 210 again. By repeating a cycle like this, the NOx is reduced and the exhaust gas in which the NOx is reduced reaches the other end face of the cell 121 and then is exhausted from this end face of the honeycomb structure.

As described above, in a conventional honeycomb structure, the NOx in the exhaust gas can be converted by the function of the NOx adsorption layer 210 and the ammonia adsorption layer 220 each supported on the cell walls 123P of the honeycomb structure.

However, it is necessary to note that the cordierite itself included in the cell walls 123P does not react in the NOx conversion reaction. In other words, it is necessary to carry out all the reactions for converting the NOx in the exhaust gas only by the two layers, the NOx adsorption layer 210 and the ammonia adsorption layer 220 each supported on the cell walls 123P.

Therefore, to increase the efficiency of converting NOx in the honeycomb structure, it may be necessary to support sufficient amounts of the NOx adsorption layer 210 and the ammonia adsorption layer 220 on the cell walls 123P. To this end, it may be necessary to increase the thicknesses of the two layers 210 and 220 or to elongate the whole length of the cordierite which is a supporting body. Otherwise, it may be necessary to increase the frequency of a rich-spiking operation.

However, when the thickness of each layer is increased, the size of the opening of the cell walls becomes smaller. As a result, when exhaust gas is introduced, a pressure loss is disadvantageously increased. Further, when the total length of the cordierite (cell walls) is extended, there may arise a problem of the installation space and the weight. Further, when the frequency of the rich-spiking operation is increased, the fuel consumption is disadvantageously increased.

On the other hand, in a honeycomb structure according to an embodiment of the present invention, the cell walls include materials different from those in the conventional honeycomb structure.

FIG. 5 shows a schematic enlarged view of a cross section of the cell wall of the honeycomb structure according to an embodiment of the present invention.

In the honeycomb structure 100 according to an embodiment of the present invention, the cell wall 123 of the honeycomb unit 130 includes a material (such as ceria) capable of adsorbing NOx and a material (such as zeolite) capable of adsorbing ammonia. For example, in the honeycomb unit 130, the cell wall 123 includes a mixture of ceria and zeolite, and a noble metal catalyst (such as platinum) is supported on the cell wall. Further, in the honeycomb structure 100 according to an embodiment of the present invention, a preliminary layer 260 is formed on the surface of the cell wall 123. The preliminary layer 260 includes, for example, zeolite. In the FIG. 5, it is illustrated that the preliminary layer 260 is uniformly formed as a “layer”. However, as described with reference to FIG. 4 above, it is obvious that the preliminary layer 260 is not uniformly (continuously) formed as a “layer”.

In the honeycomb structure 100 according to an embodiment of the present invention, the cell walls 123 including such materials do not include cordierite that does not contribute to the NOx conversion reaction unlike the conventional honeycomb structure. Therefore, it may become easy to use all the materials included in the honeycomb structure 100 (namely, in the honeycomb unit 130) for the NOx conversion reaction. Therefore advantageously, it may become easy to significantly improve the NOx conversion capability.

Further, in the honeycomb structure according to an embodiment of the present invention, since a necessary and sufficient amount of a material for adsorbing NOx and a material for adsorbing ammonia are included, it is not necessary to increase the thicknesses of the NOx adsorption layer and the ammonia adsorption layer on the cell walls 123P, to extend the total length of the honeycomb structure, or to increase the frequency of the rich-spiking operation. Therefore advantageously, in the honeycomb structure according to an embodiment of the present invention, it may become easy to reduce the weight, the size, and the fuel consumption.

In the honeycomb structure 100 according to an embodiment of the present invention, it should be noted that the preliminary layer 260 formed on the surface of the cell walls 123 adsorbs ammonia like a conventional ammonia adsorption layer 220. The preliminary layer 260 is just a member preliminarily provided for ensuring that ammonia is not exhausted outside the honeycomb structure. Namely, according to an embodiment of the present invention, the cell walls 123 of the honeycomb structure already includes a material contributing to the adsorption of ammonia, so that most of ammonia generated in the above-mentioned NOx conversion process is adsorbed in the ammonia adsorption material in a skeleton structure part of the cell walls 123. If any of the ammonia should not be adsorbed in the skeleton structure part of the cell walls 123, the preliminary layer 260 adsorbs the small amount of ammonia that has not be adsorbed in the cell walls 123, so as to ensure that the ammonia generated in a reaction process is not exhausted outside of the honeycomb structure. Therefore, in the honeycomb structure 100 according to an embodiment of the present invention, the thickness of the preliminary layer 260 may easily be made sufficiently less than that of the conventional ammonia adsorption layer 220.

Further advantageously, the honeycomb structure according to an embodiment of the present invention can maintain stable NOx conversion performance for a period longer than a conventional honeycomb structure does due to the following reasons. The zeolite used in the ammonia adsorption layer 220 in a conventional honeycomb structure is likely to absorb water vapor in a high temperature environment, which may cause a hydrolysis reaction of ammonia. When such a reaction occurs, the aluminum is removed from the zeolite, and accordingly the ammonia adsorption capability of the ammonia adsorption layer 220 may become easily degraded. As a result, generally, the NOx conversion performance may become easily degraded over time. On the other hand, in the honeycomb structure according to an embodiment of the present invention, the zeolite in the cell walls is adjacent to the ceria on which a noble metal catalyst is supported. Because of this feature, the water vapor preferentially reacts with the noble metal catalyst on the ceria rather than with the zeolite, which makes it difficult to cause the hydrolysis reaction of ammonia. Therefore, in the honeycomb structure according to an embodiment of the present invention, it may become easy to maintain stable NOx conversion performance for a longer period of time.

In the honeycomb unit 130 according to an embodiment of the present invention, it is preferable that the compounding ratio (weight ratio) of the material (such as ceria) for adsorbing the NOx in the cell walls to the material (such as zeolite) for adsorbing the ammonia is in the range of from approximately 2:1 to approximately 10:1. From a stoichiometric viewpoint, when the compounding ratio of the two materials is within this range, the ammonia generated with the NOx adsorption material may become easy to be effectively adsorbed by the ammonia adsorption material.

Further preferably, the amount of the preliminary layer 260 coated on the cell walls 123 is in the range of approximately 5 g/L to approximately 15 g/L.

The honeycomb unit 130 according to an embodiment of the present invention includes inorganic binder in addition to the ceria particles and the zeolite particles. The honeycomb unit 130 according to an embodiment of the present invention may further include inorganic fibers.

As the material of the inorganic binder, inorganic sol and a clay binder and the like may be used. The specific examples of the inorganic sol is alumina sol, silica sol, titania sol, water glass and the like. The specific examples of the clay binders is double chain structural type clay such as white clay, kaolin, montmorillonite, sepiolite, attapulgite and the like. Any of these may be used alone or in combination of two or more kinds.

Among these materials, it is preferable to use at least one selected from a group consisting of alumina sol, silica sol, titania sol, water glass, sepiolite and attapulgite.

Further, when inorganic fibers are further included in the honeycomb unit, preferably, a material of the inorganic fibers is alumina, silica, silicon carbide, silica-alumina, glass, potassium titanate, aluminum borate and the like. Any of these may be used alone or in combination of two or more. Among the above materials, more preferably, aluminum borate is used. The inorganic fibers include whiskers.

The lower limit of a total amount of ceria particles and zeolite particles in the honeycomb unit is preferably approximately 30 wt %, more preferably approximately 40 wt %, and still more preferably approximately 50 wt %. On the other hand, the upper limit of the total amount of ceria particles and zeolite particles in the honeycomb unit is preferably approximately 90 wt % and more preferably approximately 80 wt %. When the total amount of these particles is equal to or more than approximately 30 wt %, the amount of the particles contributing to the NOx conversion may hardly be reduced relatively. Therefore, the NOx conversion performance may hardly be degraded. On the other hand, when the total amount of these particles is equal to or less than approximately 90 wt %, the strength of the honeycomb unit may hardly be reduced.

The inorganic binder content as solids content is preferably equal to or more than approximately 5 wt %, more preferably equal to or more than approximately 10 wt %, and still more preferably equal to or more than approximately 15 wt %. On the other hand, the inorganic binder content as solids content is preferably equal to or less than approximately 50 wt %, more preferably equal to or less than approximately 40 wt %, and still more preferably equal to or less than approximately 35 wt %. When the amount of inorganic binder as a solid content is equal to or more than approximately 5 wt %, the strength of the manufactured honeycomb unit may hardly be reduced. On the other hand, when the amount of inorganic binder as a solid content is equal to or less than approximately 50 wt %, the molding capability of the raw material composition may hardly be degraded.

When the honeycomb unit includes inorganic fibers, the lower limit of the total amount of the inorganic fibers is preferably approximately 3 wt %, more preferably approximately 5 wt %, and still more preferably approximately 8 wt %. On the other hand, the upper limit of the total amount of the inorganic fibers is preferably approximately 50 wt %, more preferably approximately 40 wt %, and still more preferably approximately 30 wt %. When the inorganic fibers content is equal to or more than approximately 3 wt %, the effect of improving the strength of the honeycomb unit may hardly be degraded. When the inorganic fibers content is equal to or less than approximately 50 wt %, the amount of ceria particles and zeolite particles each contributing to the NOx conversion may hardly be reduced relatively. As a result, the NOx conversion performance may hardly be degraded.

The shape of the cross section perpendicular to the longitudinal direction of the honeycomb unit 130 is not specifically limited, but any shape may be used as long as the shape allows the honeycomb units to join with each other by interposing adhesive layers. The honeycomb unit 130 may have any shape including a square, a rectangle, a hexagon, a fan shape and the like.

Further, the shape of the cross section perpendicular to the longitudinal direction of the cell 121 of the honeycomb unit 130 is not specifically limited, but may be a triangle, a polygonal shape and the like in addition to a square.

The cell density of the honeycomb unit 130 is preferably in the range of approximately 15.5 units/cm² to approximately 186 units/cm² (approximately 100 cpsi to approximately 1200 cpsi), more preferably in the range of approximately 46.5 units/cm to approximately 170 units/cm² (approximately 300 cpsi to approximately 1100 cpsi), and still more preferably in the range of approximately 62.0 units/cm² to approximately 155 units/cm² (approximately 400 cpsi to approximately 1000 cpsi).

The thickness of the cell wall 123 of the honeycomb unit 130 (before a noble metal catalyst is supported) is not specifically limited, but the lower limit and the upper limit of the thickness of the cell wall 123 of the honeycomb unit 130 is preferably approximately 0.1 mm and approximately 0.4 mm, respectively.

On the other hand, the honeycomb structure 100 according to an embodiment of the present invention may have any shape including a cylindroid shape, a square pillar shape, a hexagonal pillar shape and the like in addition to a pillar shape as shown in FIG. 1.

The coating layer 120 of the honeycomb structure 100 is formed of a paste (coating layer paste) including inorganic particles, inorganic fibers, inorganic binder, and organic binder as the raw material. As the inorganic particles, the particles of alumina, silica, zirconia, titania, ceria, mullite, zeolite, or the like are used. Any of these may be used alone or in combination of two or more kinds. As the inorganic fibers and the inorganic binder, the above-mentioned material may be used. Further, as the organic binder, polyvinyl alcohol, methylcellulose, ethylcellulose, carboxymethylcellulose, or the like may be used. Any of these may be used alone or in combination by combining two or more kinds. As the organic binder, more preferably, carboxymethylcellulose is used.

Then, the coating layer paste is applied on an outer peripheral surface of the honeycomb structure, and is dried and solidified to form the coating layer. When necessary, a pore-forming agent such as balloons which is a micro sized hollow sphere having oxide-based ceramic as a component, spherical acrylic particles, graphite or the like may be added to the paste as the raw material. The thickness of the coating layer is preferably in the range of approximately 0.1 mm to approximately 0.2 mm.

Further, in the honeycomb structure 100 according to an embodiment of the present invention, the same materials are used in both the adhesive layer 150 and the coating layer 120. However, the materials used in the adhesive layer 150 may be different from those in the coating layer 120, and the compounding ratio of the materials in the in the adhesive layer 150 may be different from that in the coating layer 120.

Such a honeycomb structure 100 may be used in a treatment apparatus for exhaust gas exhausted from a diesel engine and the like.

### (Manufacturing Method of Honeycomb Structure)

Next, a method of manufacturing the honeycomb structure according to an embodiment of the present invention is described.

First, a honeycomb unit molded body is manufactured by extrusion molding and the like using a raw material paste including inorganic particles (ceria particles and zeolite particles) and inorganic binder as a main component and inorganic fibers added when necessary.

As the raw material paste, organic binder, dispersion medium, and molding aid may be adequately added to the above materials in accordance with desired moldability. The kind of the organic binder is not specifically limited, but may be one or a combination of methylcellulose, carboxymethylcellulose, hydroxyethelcellulose, polyethyleneglycol, phenol resin, epoxy resin, and the like. The compounding amount of the organic binder is preferably in the range approximately 1 part by weight to approximately 10 parts by weight with respect to the total 100 parts by weight of the inorganic particles, inorganic binder, and inorganic fibers.

The dispersion medium is not specifically limited, but may be water, organic solvent (such as benzene), alcohol (such as methanol), and the like. The molding aid is not specifically limited, but may be ethylene glycol, dextrin, fatty acid, fatty acid soap, polyalcohol, and the like.

It is preferable that the raw material paste be mixed and kneaded. An apparatus such as a mixer or an attritor may be used for the mixing, and an apparatus such as a kneader may be used for the kneading. A method of forming the raw material paste is not specifically limited, but it is preferable to form a shape including the cell by, for example, extrusion molding.

Next, preferably, the thus-obtained molded body is dried. A drying apparatus is not specifically limited, but is used a microwave drying apparatus, a hot air drying apparatus, a dielectric drying apparatus, reduced pressure drying apparatus, vacuum drying apparatus, a freeze drying apparatus and the like. Further preferably, the obtained molded body is degreased. The degreasing condition is not specifically limited and is to be selected in accordance with a kind or amount of organic substance included in the molded body, but is preferably heated at a temperature of approximately 400° C. for approximately two hours. Next, the obtained molded body is fired. The firing condition is not specifically limited but is preferably in the range of approximately 600° C. to approximately 1200° C., and more preferably in the range of approximately 600° C. to approximately 1000° C. This is because when the firing temperature is equal to or more than approximately 600° C., the process of sintering the inorganic particles and the like is likely to progress, and the strength of the honeycomb unit may hardly be reduced. On the other hand, when the firing temperature is equal to or less than approximately 1200° C., excessive sintering of the inorganic particles and the like may hardly occur, and the specific surface area per unit volume of the honeycomb unit may hardly be reduced.

Next, a noble metal catalyst is supported on the cell walls of the obtained honeycomb unit. The noble metal catalyst is not specifically limited, but may be platinum, palladium, rhodium, and the like. The noble metal catalyst is supported on the cell walls by, for example, impregnating the honeycomb unit with nitric acid solution including platinum ions.

By supporting the noble metal catalyst on the cell walls of the obtained honeycomb unit, the noble metal catalyst is supported on the inorganic particles in the honeycomb unit. It should be noted that the noble metal catalyst is supported on the inorganic binder component as well in the honeycomb unit.

Next, the preliminary layer is coated on the cell walls of the honeycomb unit. The preliminary layer includes zeolite. The preliminary layer is formed by being coated on each cell wall.

Next, an adhesive layer paste which becomes an adhesive layer later is uniformly applied on a side surface of the honeycomb unit obtained by the above process. Then, the other honeycomb units are sequentially joined with each other by interposing the adhesive layer paste. This process is repeated to manufacture a honeycomb structure having a desired size (for example, 4 by 4 matrix of honeycomb units).

The adhesive layer paste is not specifically limited, but may be a mixture of inorganic binder and inorganic particles, a mixture of inorganic binder and inorganic fibers, a mixture of inorganic binder, inorganic particles, and inorganic fibers, or the like. Further, the adhesive layers paste may include organic binder. The organic binder is not specifically limited, but may be polyvinyl alcohol, methylcellulose, ethylcellulose, carboxymethylcellulose, and the like or a combination thereof.

The thickness of the adhesive layer for joining the honeycomb units with each other is preferably in the range of approximately 0.3 mm to approximately 2 mm. When the thickness of the adhesive layers is equal to or more than approximately 0.3 mm, sufficient bonding strength may easily be obtained. On the other hand, when the thickness of the adhesive layers is equal to or less than approximately 2 mm, the pressure loss may hardly be increased. It should be noted that the number of honeycomb units is appropriately selected in accordance with the size of the honeycomb structure.

Next, the honeycomb structure is heated so that the adhesive layer paste is dried and solidified to form the adhesive layer and join the honeycomb units with each other.

Then, the honeycomb structure is cut into, for example, a cylindrical shape by using a diamond cutter to manufacture a honeycomb structure having a desired outer peripheral shape.

Next, a coating layer paste is applied on the outer peripheral surface (side surface) of the honeycomb structure. Then the coating layer paste is dried and solidified to form the coating layer. The coating layer paste is not specifically limited, but may be the same as or different from the adhesive layer paste. Further, the compounding ratio of the materials in the in the coating layer paste may be the same as or different from that in the adhesive layer paste. The thickness of the coating layer is not specifically limited.

After plural honeycomb units are joined with each other by the interposing adhesive layers (or after the coating layer is formed when the coating layer is applied), it is preferable to degrease the assembly (honeycomb structure). By doing this process, when the adhesive layer paste and the coating layer paste include organic binder, the organic binder can be removed. The degreasing condition is to be selected in accordance with a kind or amount of organic substance included in the pastes, but is generally heated at a temperature of approximately 400° C. for approximately two hours.

By doing the above procedure, the honeycomb structure shown in FIG. 1 is manufactured.

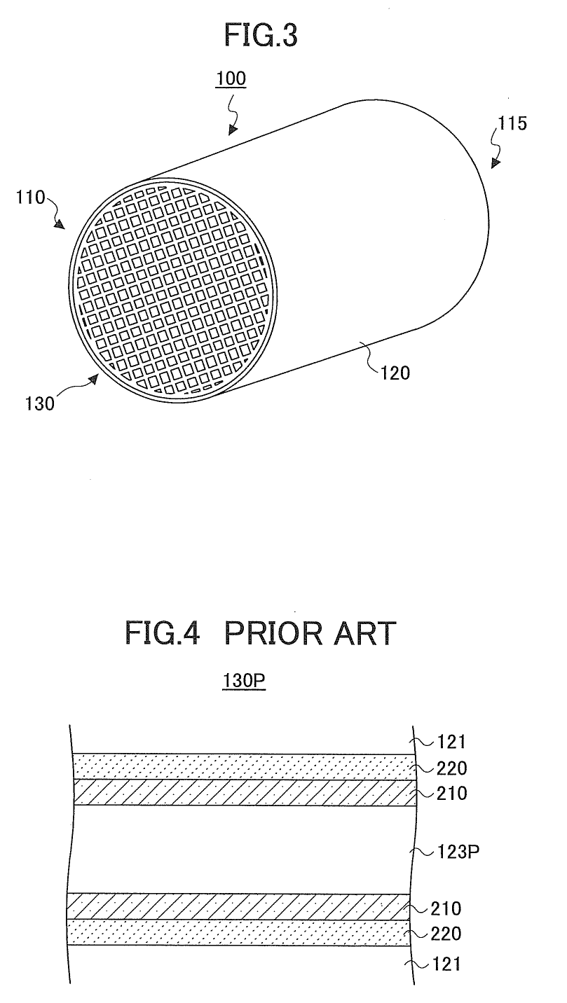

The honeycomb structure having plural honeycomb units as shown in FIG. 1 is described above. The present invention is not limited to the honeycomb structure as shown in FIG. 1. For example, a honeycomb structure may have a single honeycomb unit as shown in FIG. 3. In this case, the coating layer may be or may not be formed.

### EXAMPLE

Next, examples according to the embodiment of the present invention are described.

### Example 1

First, 2000 parts by weight of ceria particles (average particle diameter: 2 μm), 750 parts by weight of zeolite particles (average particle diameter: 2 μm), 345 parts by weight of alumina fibers (average fiber diameter: 6 μm; average fiber length: 100 μm), and 2200 parts by weight of alumina sol (solid concentration: 20 wt %) are mixed to obtain a mixture. 320 parts by weight of methylcellulose as organic binder, a small amount of a plasticizing agent, a surface-activating agent, and a lubricant agent are added to the mixture and are mixed and kneaded to obtain a mixed composition. Then, the mixed composition is extrusion molded by using an extrusion molding apparatus to obtain a raw molded body.

Next, the raw molded body is fully dried by using a microwave drying apparatus and a hot air drying apparatus, then degreased at a temperature of 400° C. for two hours, and then fired at a temperature of 700° C. for two hours to obtain a porous honeycomb unit having a square pillar shape(sizes: 35 mm (breadth)×35 mm (width)×150 mm (length)). The cell density of the porous honeycomb unit is 93 units/cm², and thickness of the partition walls is 0.2 mm.

Next, the porous honeycomb unit having a square pillar shape is cut along the axis directions by using a diamond cutter to obtain an evaluation sample of a porous honeycomb unit having a cylindrical shape (sizes: 25 mm (diameter)×60 mm (length)).

Next, the thus-obtained porous honeycomb unit (evaluation sample) having a cylindrical shape is impregnated with platinum nitrate solution, and then is heated at a temperature of 600° C. for one hour to support platinum on the cell walls. The platinum weight per unit volume in the honeycomb unit having a cylindrical shape is 3 g/L.

Next, the thus-obtained honeycomb unit having a cylindrical shape is wash-coated with zeolite slurry, and then is heated at a temperature of 600° C. for one hour. By doing this process, the preliminary layer including zeolite is coated on the cell walls. The coating weight of zeolite per unit volume is 5.0 g/L.

### Example 2

Next, by doing the same method as in Example 1, a honeycomb unit of Example 2 (evaluation sample) is manufactured. However, in this Example 2, the coating weight of zeolite in the preliminary layer is 10.0 g/L.

### Example 3

Next, by doing the same method as in Example 1, a honeycomb unit of Example 3 (evaluation sample) is manufactured. However, in this Example 3, the coating weight of zeolite in the preliminary layer is 15.0 g/L.

### Example 4

Next, by doing the same method as in Example 1, a honeycomb unit of Example 4 (evaluation sample) is manufactured. However, in this Example 4, 2250 parts by weight of ceria particles (average particle diameter: 2 μm), 500 parts by weight of zeolite particles (average particle diameter: 2 μm) are used. The other conditions are the same as in Example 1.

### Example 5

Next, by doing the same method as in Example 4, a honeycomb unit of Example 5 (evaluation sample) is manufactured. However, in this Example 5, the coating weight of zeolite in the preliminary layer is 10.0 g/L.

### Example 6

Next, by doing the same method as in Example 4, a honeycomb unit of Example 6 (evaluation sample) is manufactured. However, in this Example 6, the coating weight of zeolite in the preliminary layer is 15.0 g/L.

### Comparative Example 1

Next, by doing the same method as in Example 1, a honeycomb unit of Comparative example 1 (evaluation sample) is manufactured. However, in this Comparative example 1, 2700 parts by weight of ceria particles (average particle diameter: 2 μm) are used but no zeolite particles are added. Further, a zeolite preliminary layer is not coated on the surface of the cell walls.

### Comparative Example 2

Next, by doing the same method as in Example 1, a honeycomb unit of Comparative example 2 (evaluation sample) is manufactured. However, in this Comparative example 2, 2200 parts by weight of ceria particles (average particle diameter: 2 μm) and 500 parts by weight of zeolite particles (average particle diameter: 2 μm) are used to form the honeycomb unit. Further, a zeolite preliminary layer is not coated on the surface of the cell walls.

Table 1 collectively shows the data of the compounding amount (parts by weight) of the materials (ceria and zeolite) and the coating amount of the zeolite preliminary layer of the honeycomb units with respect to each of the Examples and Comparative examples.

TABLE 1

| | COMPOUNDING | | COATING | | | | |
|---|---|---|---|---|---|---|---|
| | AMOUNT (PARTS | | AMOUNT OF | | | | |
| | BY WEIGHT) | | PRELIMINARY | NOx CONVERSION RATE (%) | | | AMMONIA |
| | CERIA | ZEOLITE | LAYER (g/L) | 200° C. | 300° C. | 400° C. | DETECTION |
| EXAMPLE 1 | 2000 | 750 | 5.0 | 97 | 94 | 85 | NO |
| EXAMPLE 2 | 2000 | 750 | 10.0 | 97 | 95 | 85 | NO |
| EXAMPLE 3 | 2000 | 750 | 15.0 | 97 | 94 | 85 | NO |
| EXAMPLE 4 | 2250 | 500 | 5.0 | 93 | 87 | 82 | NO |
| EXAMPLE 5 | 2250 | 500 | 10.0 | 93 | 88 | 82 | NO |
| EXAMPLE 6 | 2250 | 500 | 15.0 | 93 | 88 | 82 | NO |
| COMPARATIVE | 2700 | — | — | 90 | 87 | 76 | YES |
| EXAMPLE 1 | | | | | | | |
| COMPARATIVE | 2200 | 500 | — | 93 | 88 | 82 | YES |
| EXAMPLE 2 | | | | | | | |

### (Evaluation of NOx Conversion Performance)

The NOx conversion performance with respect to Examples 1 through 6 and Comparative examples 1 and 2 is evaluated by using the corresponding evaluation samples prepared by the above-mentioned methods. In the evaluation of the NOx conversion performance, the mixed gas simulating the lean operating condition and the mixed gas simulating the rich-spiking operating condition are introduced in each honeycomb unit so as to carry out the NOx conversion. Then, the NO (nitric oxide) amount in the gas exhausted from each honeycomb structure is measured.

Table 2 shows the composition of the two kinds of the mixed gas simulating the lean and rich-spiking operations, respectively. In this evaluation, first, the lean gas is introduced in the honeycomb structure for 55 seconds and then the rich gas introduced for 5 second. This cycle is repeated until the NO concentration in the exhaust gas becomes almost stable.

TABLE 2

| | GAS CONCENTRATION | |
|---|---|---|
| GAS | | IN RICH-SPIKING |
| COMPOSITION | IN LEAN OPERATION | OPERATION |
| CO₂ | 6 vol % | 6 vol % |
| O₂ | 6 vol % | — |
| NO | 110 ppm | 110 ppm |
| CO | 500 ppm | 2% |
| THC | 900 ppm* | 900 ppm* |
| (HYDRO CARBON) | | |
| H₂O | 7 vol % | 7 vol % |
| N₂ | Balance | Balance |
| SV | 50000/hr | 47000/hr |

*CARBON AMOUNT CRITERION

NO concentration is measured by using “MEXA-7100D” (HORIBA Ltd.) having an NO detection limit of 0.1 ppm.

The temperature (of the honeycomb unit and the simulation gas) during the evaluations is maintained at a temperature of 200° C., 300° C., or 400° C.

To evaluate the NOx conversion performance, the NOx conversion rate “N” given as follows is used.

N(%)={(NO concentration of mixed gas before the mixed gas is introduced in honeycomb unit)−(NO concentration of the exhaust gas exhausted from the honeycomb unit)}/(NO concentration of mixed gas before the mixed gas is introduced in honeycomb unit)×100 Formula (3)

Further, in addition to the evaluation of the NOx conversion performance, the ammonia amount in the gas exhausted from each of the honeycomb units is measured. To measure the ammonia amount, the ammonia detecting apparatus “MEXA-1170NX” (HORIBA Ltd.) having a measurement limit of 0.1 ppm is used.

The results of the measurement are shown in the right end columns of Table 1. The results shows that each of the honeycomb units according to an embodiment of the present invention (evaluation samples of Example 1 through 6) has a higher NOx conversion rate than the honeycomb unit (evaluation sample) of Comparative sample 1 at any of the temperatures. Further, ammonia is detected in the exhaust gas from each honeycomb unit (evaluation sample) of Comparative examples 1 and 2. However, no ammonia is detected from any of the honeycomb units (evaluation samples) of Examples 1 through 6.

As described above, the honeycomb structure according to an embodiment of the present invention improves the NOx conversion performance and shows an excellent characteristic without exhausting ammonia.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teachings herein set forth.

What is claimed is:

1. A honeycomb structure comprising:
at least one honeycomb unit having one end face and another end face opposite to the one end face along a longitudinal direction of the at least one honeycomb unit, the at least one honeycomb unit comprising:
cell walls extending along the longitudinal direction from the one end face to the another end face to define plural cells;
an inorganic binder;
inorganic particles comprising first and second materials, the first material including NOx adsorption material, the second material including ammonia adsorption material; and
a third material provided on the cell walls.

2. The honeycomb structure according to claim 1, wherein
the first material includes ceria, and the second and the third materials include zeolite.

3. The honeycomb structure according to claim 1, wherein
a weight ratio of the first material to the second material is in a range of from approximately 2:1 to approximately 10:1.

4. The honeycomb structure according to claim 1, wherein
a weight ratio of the second material to the third material is in a range of from approximately 10:1 to approximately 20:1.

5. The honeycomb structure according to claim 1, wherein the third material is substantially same as the second material.

6. The honeycomb structure according to claim 1, wherein
the second material comprises zeolite which is ion-exchanges with at least one of Fe, Cu, Ni, Zn, Mn, and Co.

7. The honeycomb structure according to claim 1, wherein
the inorganic binder includes at least one of alumina sol, silica sol, titania sol, water glass, sepiolite, and attapulgite.

8. The honeycomb structure according to claim 1, wherein
the at least one honeycomb unit further includes inorganic fibers.

9. The honeycomb structure according to claim 8, wherein
the inorganic fibers is at least one of alumina, silica, silicon carbide, silica-alumina, glass, potassium titanate, and aluminum borate.

10. The honeycomb structure according to claim 1, wherein
a noble metal catalyst is provided on the inorganic particles.

11. The honeycomb structure according to claim 1, wherein
an amount of the third material provided on the cell walls is in a range of approximately 5 g/L to approximately 15 g/L.

12. The honeycomb structure according to claim 2, wherein
a total amount of ceria particles and zeolite particles in the at least one honeycomb unit is in a range of approximately 30 wt % to approximately 90 wt %.

13. The honeycomb structure according to claim 1, wherein
an amount of the inorganic binder as a solid content in the at least one honeycomb unit is in a range of approximately 5 wt % to approximately 50 wt %.

14. The honeycomb structure according to claim 8, wherein
an amount of the inorganic fibers in the at least one honeycomb unit is in a range of approximately 3 wt % to approximately 50 wt %.

15. The honeycomb structure according to claim 1, wherein
the at least one honeycomb unit comprises plural honeycomb units and wherein the honeycomb structure comprises adhesive layers to join the plural honeycomb units with each other.

16. The honeycomb structure according to claim 1, wherein
the at least one honeycomb unit comprises a single honeycomb unit.

17. A method of manufacturing a honeycomb structure including at least one honeycomb unit, the method comprising:
manufacturing at least one honeycomb unit molded body using a raw material paste including inorganic particles and an inorganic binder;
firing the at least one honeycomb unit, molded body to obtain the at least one honeycomb unit which comprises a plurality of cell walls extending from one end face to another end face of the at least one honeycomb unit along a longitudinal direction of the at least one honeycomb unit to define a plurality of cells;
providing a noble metal catalyst on the cell walls of the at least one honeycomb unit; and
coating a preliminary layer on the cell walls of the honeycomb unit.

18. The method of manufacturing a honeycomb structure according to claim 17, wherein
the inorganic particles include NOx adsorption material and ammonia adsorption material.

19. The method of manufacturing a honeycomb structure according to claim 17, wherein
the preliminary layer includes zeolite.

20. The method of manufacturing a honeycomb structure according to claim 17, wherein
the at least one honeycomb unit molded body is manufactured by extrusion molding.

21. The method of manufacturing a honeycomb structure according to claim 17, wherein
the noble metal catalyst is provided on the cell walls by impregnating the at least one honeycomb unit with nitric acid solution including platinum ions.

22. The method of manufacturing a honeycomb structure according to claim 21, wherein
the noble metal catalyst is supported on the inorganic particles in the at least one honeycomb unit.

23. The method of manufacturing a honeycomb structure according to claim 21, wherein
the noble metal catalyst is supported on the inorganic binder in the at least one honeycomb unit.

24. The method of manufacturing a honeycomb structure according to claim 17, further comprising
interposing an adhesive layer paste between plural honeycomb units; and
drying and solidifying the adhesive layer paste to form an adhesive layer and join the plural honeycomb units with each other.

25. The method of manufacturing a honeycomb structure according to claim 24, wherein the adhesive layer paste is applied on a side surface of the at least one honeycomb unit to connect the plural honeycomb unit.

26. The method of manufacturing a honeycomb structure according to claim 17, further comprising
cutting the honeycomb structure so as to have a desired outer peripheral shape.

27. The method of manufacturing a honeycomb structure according to claim 18, wherein
the NOx adsorption material includes ceria.

28. The method of manufacturing a honeycomb structure according to claim 18, wherein
the ammonia adsorption material includes zeolite.

29. The method of manufacturing a honeycomb structure according to claim 17, wherein
the inorganic binder includes at least any one of alumina sol, silica sol, titania sol, water glass, sepiolite, and attapulgite.

30. The method of manufacturing a honeycomb structure according to claim 17, wherein
the at least one honeycomb unit further includes inorganic fibers.

31. The method of manufacturing a honeycomb structure according to claim 17, wherein
the inorganic fibers comprises at least one of alumina, silica, silicon carbide, silica-alumina, glass, potassium titanate, and aluminum borate.

32. The honeycomb structure according to claim 1, wherein the at least one honeycomb unit has a pillar shape.

33. The honeycomb structure according to claim 1, wherein the third material is coated on the cell walls.
